(19) United States
(12) Patent Application Publication
(10) Pub. No.: US 2013/0168913 A1
(43) Pub. Date: Jul. 4, 2013

(54) ZERO POINT CLAMPING DEVICE

(71) Applicant: Marcel Schluessel, Bassersdorf (CH)

(72) Inventor: Marcel Schluessel, Bassersdorf (CH)

(73) Assignee: GRESSEL AG, Aadorf (CH)

(21) Appl. No.: 13/810,936

(22) PCT Filed: Jul. 12, 2011
(86) PCT No.: PCT/EP11/61860

§ 371 Date: Mar. 15, 2013

(30) Foreign Application Priority Data
Jul. 19, 2010 (DE) 202010010413.0

(51) Int. Cl. B23Q 1/00

(52) U.S. Cl. CPC B23Q 1/0072
USPC 269/309

(57) ABSTRACT

The invention relates to a zero point clamping device for clamping a first component (1) to a second component (2) at a precise position, wherein the first component (1) comprises at least one draw-in bolt (3) and the second component (2) comprises a receiving opening (4) for the draw-in bolt (3) and a clamping mechanism (5) for drawing in the draw-in bolt (3) into the receiving opening (4). According to the invention, the receiving opening (4) comprises an insertion area (12) having larger outer dimensions than the draw-in bolt (3) and a contact area (13) radially offset relative to the insertion area (12) and having at least one contact surface (14) having a circular shape in top view.

The present invention relates to a zero-point clamping device according to the preamble of claim 1.

This type of zero-point clamping device is used, e.g., for chucking clamping systems, pallets or workpieces accurately positioned onto machining tables of machine tools or the like. As a rule, commercially available zero-point systems work with draw-in bolts which are inserted into a receiving opening of a clamping plate and pulled into the receiving opening by means of a clamping mechanism. To ensure accurate positioning and guidance with high test-retest reliability, however, the receiving openings and the associated draw-in bolts must be machined with extremely high precision and a high accuracy of fit, which, if not achieved, can lead to problems when the draw-in bolts are inserted into the receiving openings. In particular, the risk is that the draw-in bolt becomes cross-threaded. To solve this problem, conical clamping surfaces have been proposed. However, the problem with this solution is that the position in the axial direction of the draw-in bolts may change as a function of the draw-in force.

Thus, the problem to be solved by the present invention is to make available a zero-point clamping device of the type described above which makes it possible to easily insert the draw-in bolt into the receiving opening, and at the same time ensures an accurate and repeatably precise positioning of the components.

This problem is solved by a device with the features of claim 1. Useful advanced embodiments and practical design layouts of the invention are the subject matter of the dependent claims.

Due to the fact that the receiving opening of the second component comprises an insertion area, the outside dimensions of which are larger than the draw-in bolt of the first component, and a contact area which is radially offset relative to the insertion area and has at least one contact surface which, in top view, has the shape of a circular arc, the draw-in bolt can be easily inserted into the associated receiving opening and accurately positioned by laterally moving the first component. Inserting the draw-in bolt into the receiving opening and laterally moving [the first component] makes clamping possible without labor-intensive and time-consuming shape changes, and the fact that the draw-in bolt is in contact with the circular arc-shaped contact surface inside the receiving opening of the second component ensures accurate positioning along the X- and Y-axis, and an upper bearing surface of the second component ensures accurate positioning along the Z-axis. This makes it possible to obtain high anchoring forces without vibrations of the clamping system. In addition, the clamping device is readily accessible and easy to operate.

The contact area can have one or a plurality of contact surfaces that are separated from one another by clearances. Using a clearance makes it possible to obtain, e.g., a defined two-point support for the draw-in bolt inside the receiving opening.

According to a useful embodiment, the draw-in bolt has a circular cross section and comprises cylindrical outer contact surfaces. However, the draw-in bolt can also have a polygonal design. In an embodiment especially useful for reasons relating to production, the receiving opening, in top view, can be oval, which oval receiving opening can be produced by creating two bores with different diameters.

The clamping mechanism preferably has a slide, which can be moved at right angles to the receiving opening and which has a wedge surface which engages in a slanted clamping surface of a wedge-shaped groove of the draw-in bolt. This allows the draw-in bolt not only to be laterally pressed against the contact area but also to be pulled in in a defined manner.

Additional distinctive features and advantages of the present invention follow from the description of a preferred practical example below which is illustrated in the drawing. As can be seen:

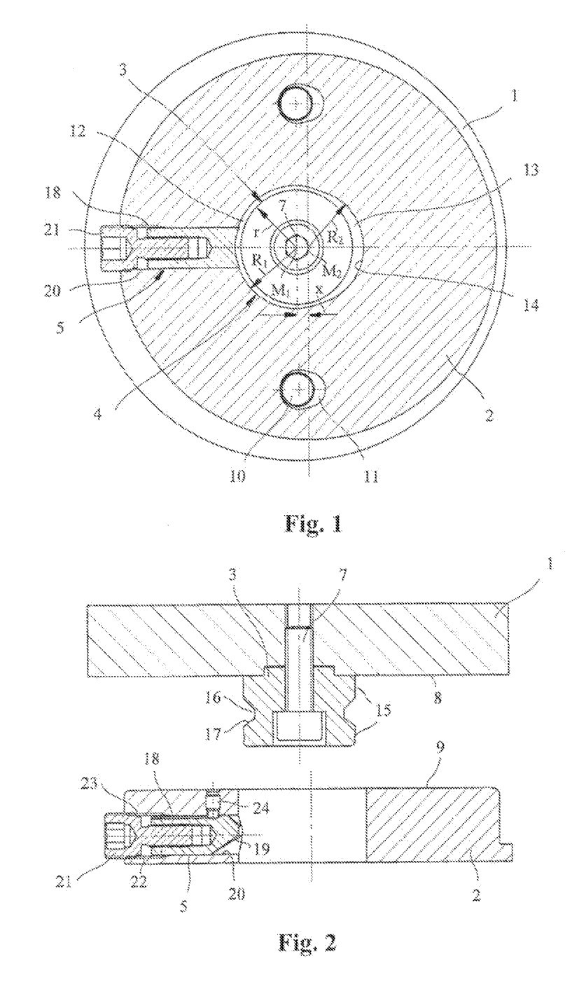

FIGS. 1 and 2 show a cross section and a longitudinal section through a zero-point clamping device in the unclamped state;

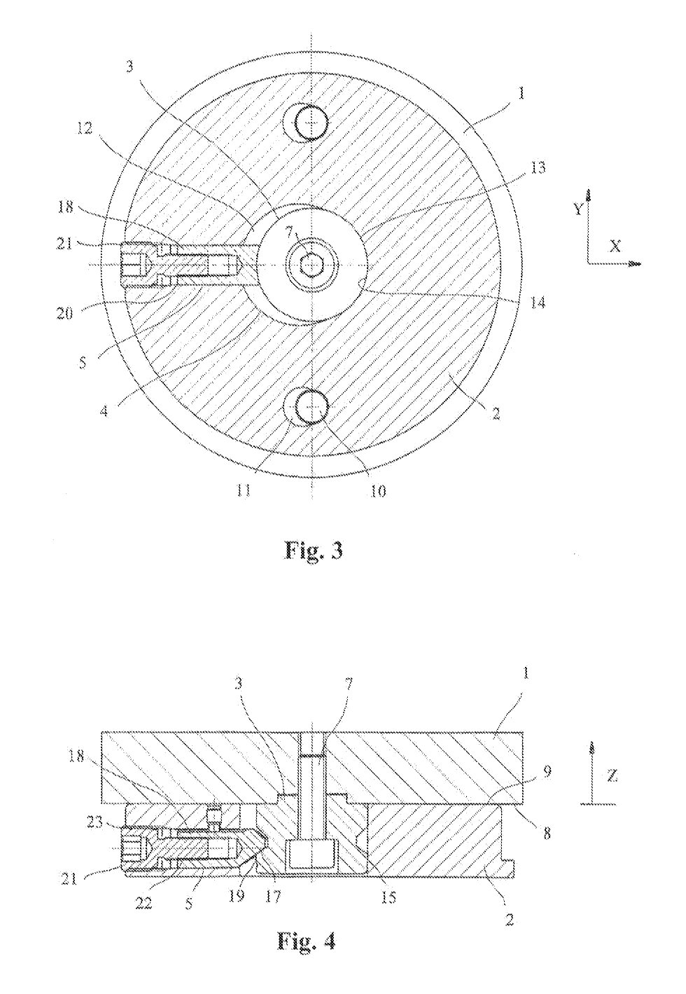

FIGS. 3 and 4 show a cross section and a longitudinal section through a zero-point clamping device in the clamped state; and

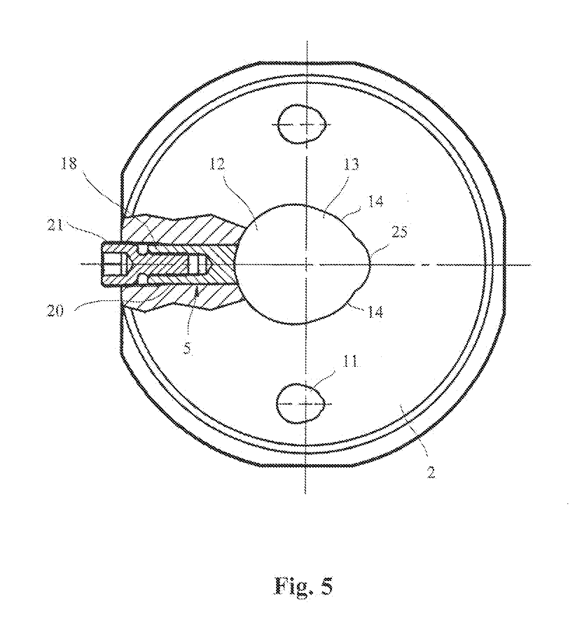

FIG. 5 shows yet another practical example of a zero-point clamping device.

The zero-point clamping device, which in FIGS. 1 and 2 is shown in the unclamped state and in FIGS. 3 and 4 in the clamped state, for clamping a first component 1 accurately positioned to a second component 2, which in this case is a circular clamping plate, comprises a draw-in bolt 3 which is disposed on the first component 1 and which, by means of a clamping mechanism 5 disposed in the second component 2, can be positioned inside the receiving opening 4 and can be pulled into said opening.

As FIG. 2 shows, in addition to the draw-in bolt 3, which is attached by means of a screw 7 to the lower surface of the first component, the first component 1 has a lower contact surface 8 for making contact with an upper support surface 9 of the second component 2. The contact established between the lower contact surface 8 of the first component 1 and the upper support surface 9 of the second component 2, which in this case is a clamping plate, makes it possible to fix the position of the first component 1 to be clamped in a first axis (Z-axis). However, the lower support surface 8 can also take the form of an annular surface and be disposed on the draw-in bolt 3. In addition, as seen in FIG. 1, two diametrically oppositely lying, downwardly projecting torsion-proof bolts 10 that mate with associated torsion-proof bores 11 inside the second component 2 are disposed in the first component 1.

As especially well illustrated in FIG. 1, the receiving opening 4 disposed in the second component 2 comprises an insertion area 12 having outside dimensions larger than the draw-in bolt 3 and a contact area 13 which is radially offset relative to the insertion area 12 and which has a contact surface 14 which, in top view, has the shape of a circular arc. In the embodiment shown, the receiving opening 4, in top view, has an oval shape and, in the insertion area 12, has a radius R₁ which is larger than the radius r of the draw-in bolt 3. The contact area 13, on the other hand, has a smaller radius R₂ which corresponds to the radius r of the draw-in bolt 3. The center M₂ of the circular arc-shaped contact area 13 is offset by the value x relative to the center M₁ of the insertion area 12. Using a simple manufacturing method, the receiving opening 4 can be produced by creating two bores having different diameters and being offset by the value x. The two torsion-proof bores 11 also have an oval shape as well as a larger insertion area and a smaller contact area and are oriented in accordance with the receiving opening 4 in such a manner that the draw-in bolt 3, which has a circular cross section, and the two torsion-proof bolts 10, which also have a circular cross section, can be inserted in the position shown in FIGS. 1 and 2 by simply lowering the first component 1 into the insertion areas of the receiving opening 4 and of the torsion-proof bores 11, respectively. As illustrated in FIG. 2, the draw-in bolt 3 comprises outer cylindrical contact surfaces 15 and a circumferential groove 16 in the shape of a wedge-shaped groove with a lower clamping surface 17.

The clamping mechanism 5 comprises a slide 18 which can be moved at right angles relative to the receiving opening 4 and which, at its inside end which projects into the receiving opening 4 as seen in FIG. 2, has a lower concave wedge surface 19 so as to be able to mate with the lower slanted clamping surface 17 of the draw-in bolt 3. The slide 18 is movably mounted in a bore 20, which runs perpendicular to the receiving opening 4 inside the second component, and can be moved by means of an adjusting screw 21 back and forth between an unclamped position as seen in FIGS. 1 and 2 and a clamped position as shown in FIGS. 3 and 4, with the option of actuating the slide 18 by means of a return spring (not shown) so as to reset it to the unclamped position. The adjusting screw 21 can be a differential screw with two screw threads 22 and 23 which have different pitches. In the embodiment shown, a locking screw 24 holds the slide 18 inside the bore 20 so as to protect said slide against torsion.

When, by actuating the adjusting screw 21, the slide 18 is moved from the unclamped position shown in FIGS. 1 and 2 into a clamped position seen in FIGS. 3 and 4 and its concave inside wedge surface 19 comes to mate with the groove 16 of the draw-in bolt 4 [sic; 3], the draw-in bolt 4 [sic; 3] is not only pulled into the receiving opening 4 until the lower support surface 8 of the first component 1 comes into contact with the upper support surface 9 of the second component 2 in the shape of the clamping plate so as to accurately position [the first component] along the Z-axis, but the draw-in bolt 4 [sic; 3] is also pressed laterally against the circular arc-shaped contact surface 14, thus ensuring, as shown in FIG. 3, accurate positioning in the X- and Y-axis as well. Thus, the clamping mechanism 5 ensures that the first component 1 is positioned accurately and with zero backlash not only along the Z-axis, but also along the X- and Y-axis.

FIG. 5 shows an alternative design of the receiving opening in the second component. In this embodiment, the receiving [sic; contact] area 13 has two contact surfaces 14 which, in top view, have the shape of a circular arc and which are separated from each other by an additional clearance 25. This means that it is not necessary for the contact area to be one uninterrupted area; instead, the contact area 13 can also be formed by a plurality of contact surfaces 14 that are separated from one another by clearances 25. The segment-like contact surfaces 14, as seen from the draw-in bolt 3, preferably lie in an area in the range from a minimum of 90-160° to a maximum of 200-270°. The remaining surfaces have larger dimensions than the draw-in bolt 3, thus ensuring that there is sufficient free space available for inserting the draw-in bolt into the receiving opening. The clamping mechanism 5 has a design identical to the one described in the earlier example so that components having identical functions are identified by identical reference characters.

The present invention is not limited to the practical examples described above. Thus, a single clamping plate can have a plurality of receiving openings with a single common clamping mechanism or a plurality of separate clamping means. In this case, the special advantage is that for each draw-in bolt, the clamping mechanism is actuated from the same direction or at least at a highly acute angle so that in the unclamping step, all draw-in bolts can be pushed into the larger insertion areas. This makes mounting and unmounting easier.

1. A zero-point clamping device for chucking a first component accurately positioned onto a second component, wherein the first component comprises a minimum of one draw-in bolt and the second component comprises a receiving opening for the draw-in bolt as well as a clamping mechanism for pulling the draw-in component into the receiving opening, wherein the receiving opening comprises an insertion area with outside dimensions larger than the draw-in bolt and a contact area which is radially offset relative to the insertion area and which has a minimum of one contact surface which, in top view, has the shape of a circular arc.

2. The zero-point clamping device as in claim 1, wherein characterized in that the contact area comprises two or more contact surfaces which are separated from one another by one or more clearances.

3. The zero-point clamping device as in claim 1, wherein the radius R₂ of the circular arc-shaped contact surface corresponds to the radius r of the draw-in bolt.

4. The zero-point clamping device as in claim 1, wherein the receiving opening, in top view, is oval.

5. The zero-point clamping device as in claim 1, wherein the receiving opening consists of radially offset bores with different diameters.

6. The zero-point clamping device as in claim 1, wherein the draw-in bolt has cylindrical contact surfaces.

7. The zero-point clamping device as in claim 1, wherein a protection against torsion is dedicated to the components.

8. The zero-point clamping device as in claim 7, wherein characterized in that the protection against torsion consists of a minimum of two oval torsion-proof bores in one component and a minimum of two cylindrical torsion-proof bolts in the other component.

9. The zero-point clamping device as in claim 1, wherein the clamping mechanism comprises a slide which can be moved at right angles relative to the receiving opening and which has a wedge surface which mates with a slanted clamping surface of a wedge-shaped groove of the draw-in bolt.

10. The zero-point clamping device as in claim 9, wherein the wedge surface is concave.

11. The zero-point clamping device as in claim 9, wherein the position of the slide can be adjusted by means of an adjusting screw.

12. The zero-point clamping device as in claim 11, wherein the adjusting screw comprises two different screw thread pitches.

13. The zero-point clamping device as in claim 9, wherein the slide is actuated by a spring so as to move said slide into the unclamped position.

14. The zero-point clamping device as in claim 1, wherein the slide is movably mounted in a bore of the component and secured by a locking screw.
